(19) United States
(12) Patent Application Publication
(10) Pub. No.: US 2018/0341343 A1
(43) Pub. Date: Nov. 29, 2018

(54) Physically Interactive Cloud Computing Device, System, and Method

(71) Applicant: SmartWorld, Inc., Charleston, SC (US)

(72) Inventor: Donal Charles Noonan, Charleston, SC (US)

(21) Appl. No.: 15/989,872

(22) Filed: May 25, 2018

Related U.S. Application Data
(60) Provisional application No. 62/510,841, filed on May 25, 2017.

(51) Int. Cl. G06F 3/0354; G06F 3/0484

(52) U.S. Cl. CPC G06F 3/0354; G06F 3/04842; G06F 3/04847

(57) ABSTRACT

Physically interactive cloud computing device, system, and method including a physical surface and physical objects to create, read, update, or delete cloud computing resources.

### CROSS-REFERENCE TO RELATED APPLICATIONS

U.S. Provisional Application No. 62/510,841

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### TECHNICAL FIELD

The inventive subject matter relates to cloud computing.

### BACKGROUND OF THE INVENTION

“We're entering a golden era of infrastructure.”—Martin Casado

Currently, organizations with the desire to move to cloud computing find the transition challenging and unnatural. Prior to cloud computing, organizations procured their own computing infrastructure such as network switches, servers and storage arrays. The same organizations also hired full-time information technology (IT) staff to install and maintain the infrastructure. Throughout the lifecycle of equipment, from initial purchase to retirement, there was a finite and physical aspect to the cost, location, and operation of the overall computing environment. For example, when troubleshooting an issue, an IT engineer could literally “put their hands” on the physical servers he or she wanted to investigate. Current cloud computing technology lacks such physicality, making it difficult, ineffective, and costly for organizations to understand and use. There is accordingly a need for a new and improved cloud computing device, system, and method.

### BRIEF SUMMARY OF THE INVENTION

The present invention is directed to a novel device, system, and method for creating, reading, updating, or deleting cloud computing resources with physical objects, in conjunction with an interactive surface. The interactive surface is configured to recognize the physical objects that have been placed on the surface, and to create, read, update, or delete cloud computing resources based on the structural pattern formed by the physical objects.

In one embodiment of the present invention, a user places a plurality of physical objects on an interactive surface. Each of the physical objects comprises an identifier that comprises the ID information of the object. The physical objects are placed next to each other or on top of each other to form a structural pattern. The interactive surface is configured to recognize the ID, location and orientation of the physical objects, and to derive a structural pattern from such ID, location and orientation information, and to create, read, update, or delete cloud computing resources based on such structural pattern. Each of the physical objects is assigned a cloud computing resource symbol. After a plurality of physical objects have been placed on an interactive surface, a processor that is operatively linked to the interactive surface receives information regarding the physical objects and retrieves the corresponding cloud computing resource symbol from a database of correlation relationship between an identifier and a cloud computing resource type stored in a memory that is operatively linked to the processor. The processor generates machine-readable files and web requests from the cloud computing resource symbols embedded in the structural pattern that is formed by a plurality of physical objects on an interactive surface. The object may be a button, a card, a block, a figurine, or another 2D or 3D block structure that are amenable to be placed next to each other or on top of each other to form clearly recognizable 2D or 3D structural patterns. The cloud computing resource symbol may represent any of the following symbols: compute; network; storage; virtual machine; load balancer; database; application; artificial intelligence; internet of things; analytics; or other computing resources. Sensory accessories may be operatively linked to the processor and provide interactive feedback to the user. A cloud computing solution may be deployed by placing a plurality of cards on an interactive surface, and the processor issuing web requests to a cloud service provider. Thus, cloud computing may be learned and used in a physically intuitive way.

Various additional objects, features, aspects, and advantages of the present invention will become more apparent from the following detailed description of preferred embodiments of the invention, along with the accompanying drawing in which like numerals represent like components.

### BRIEF DESCRIPTION OF THE SEVERAL VIEWS OF THE DRAWING

FIG. 1 is an exemplary schematic diagram illustrating the system process flow in accordance with one embodiment of the present invention.

FIG. 2 is an exemplary schematic diagram of the system for creating, reading, updating, or deleting cloud computing resources in accordance with one embodiment of the present invention, which illustrates the process of creating a single virtual machine using the system design in FIG. 1.

FIG. 3 is an exemplary schematic diagram of the system for creating, reading, updating, or deleting cloud computing resources in accordance with one embodiment of the present invention, which illustrates the connection of multiple interactive surface panels to change the size of the overall interactive surface.

FIG. 4 is an exemplary schematic diagram of the system for creating, reading, updating, or deleting cloud computing resources in accordance with one embodiment of the present invention, which illustrates the process of creating a cloud solution consisting of a public internet connection, load balancer, network interface card, virtual machine, and storage disk using the system design in FIG. 1.

FIG. 5 is an exemplary schematic diagram of the system for creating, reading, updating, or deleting cloud computing resources in accordance with one embodiment of the present invention, which illustrates the process of creating a cloud solution consisting of a public internet connection, load balancer, network interface card, virtual machine, and storage disk using the system design in FIG. 1.

FIG. 6 is an exemplary schematic diagram of the system for creating, reading, updating, or deleting cloud computing resources in accordance with one embodiment of the present invention, which illustrates the process of creating a cloud solution consisting of a public internet connection, load balancer, and several network interface cards, virtual machines, and storage disks using the system design in FIG. 1.

FIG. 7 is an exemplary schematic diagram of the system for creating, reading, updating, or deleting cloud computing resources in accordance with one embodiment of the present invention, which illustrates the process of creating a cloud solution consisting of a public internet connection, load balancer, and several network interface cards, virtual machines, and storage disks using the system design in FIG. 1.

FIG. 8 is an exemplary schematic diagram of the system for creating, reading, updating, or deleting cloud computing resources in accordance with one embodiment of the present invention, which illustrates the process of creating a cloud solution consisting of a public internet connection, load balancer, and several network interface cards, virtual machines, and storage disks using the system design in FIG. 1.

FIG. 9 is an exemplary schematic diagram of the system for creating, reading, updating, or deleting cloud computing resources in accordance with one embodiment of the present invention, which illustrates the process of creating a cloud solution consisting of a public internet connection, load balancer, and several network interface cards, virtual machines, and storage disks using the system design in FIG. 1.

FIG. 10 is an exemplary schematic diagram of the system for creating, reading, updating, or deleting cloud computing resources in accordance with one embodiment of the present invention.

### DETAILED DESCRIPTION OF THE INVENTION

There are many possible embodiments of the invention, some of which are described below.

Reference will now be made in detail to various embodiments of the invention, examples of which are illustrated in the accompanying drawing. While the invention will be described in conjunction with the embodiments, it will be understood that this is not intended to limit the scope of the invention to these specific embodiments. The invention is intended to cover all alternatives, modifications and equivalents within the spirit and scope of invention, which is defined by the apprehended claims.

Furthermore, in the detailed description of the present invention, specific details are set forth in order to provide a thorough understanding of the present invention. However, it will be obvious to one of ordinary skill in the art that the present invention may be practiced without these specific details. In other instances, well known methods, procedures, components, and circuits are not described in details to avoid unnecessarily obscuring a clear understanding of the present invention.

The present invention may be better understood and its numerous objects and advantages will become apparent to those skilled in the art by reference to the accompanying drawings.

The embodiments of the present invention disclose a device, system, and method for creating, reading, updating, or deleting cloud computing resources with physical objects, typically tiles, in conjunction with the use of an interactive surface.

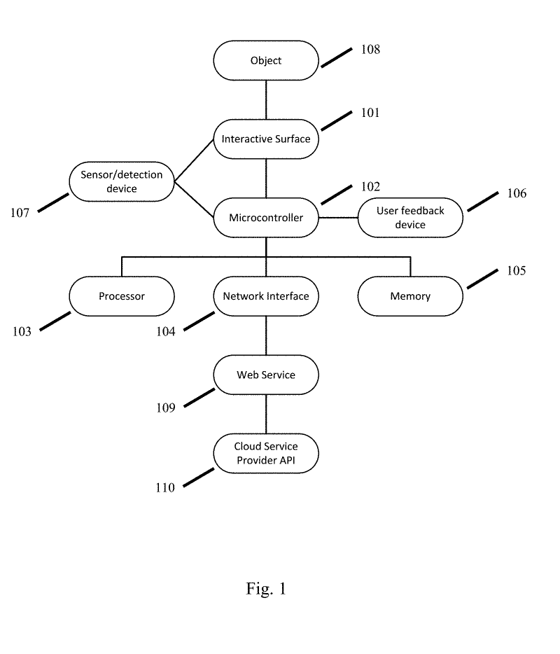

FIG. 1 is an exemplary schematic diagram illustrating the system process flow in accordance with one embodiment of the present invention. The system includes an interactive surface 101 that is operatively linked to a microcontroller 102, which includes a processor 103, network interface 104, and memory unit 105. The interactive surface 101 further includes a sensor or detection device 106 that is operatively linked to the microcontroller 102 of the interactive surface 101. The sensor or detection device 107 is configured to detect the location and unique ID of an object 108 placed on or near the interactive surface 101. The identifier of the object 108 may be a unique identification code (UID), and the UID can be encoded using a radio frequency identification chip, a pattern of capacitive tabs, or a pattern of magnetic tabs. The system described in FIG. 1 further includes a user feedback device 106 such as a liquid crystal display and/or buttons that are operatively linked to the computer system 102. The system described in FIG. 1 further includes a web service 109 that can be used to translate patterns of objects 108 detected on the interactive surface 101 into actions, such as creating, reading, updating, or deleting cloud computing resources by through programmatic requests to a cloud service provider API 110.

The user may deploy the cloud solution that he/she has created by selecting “deploy” from the user feedback device 106. The user may export the cloud solution that he/she has created by selecting “export” from the user feedback device 106. The user may validate the cloud solution that he/she has created by selecting “validate” from the user feedback device 106. The interactive surface may employ an array of RFID antennas. In this embodiment, a printed circuit board may comprise nine RFID antennas, each tuned to 13.56 MHz and may be connected to a high speed, high isolation RF switch, such as Peregrine Semiconductor 42412. The microcontroller and liquid crystal display may be mechanically fastened to the perimeter of the interactive surface.

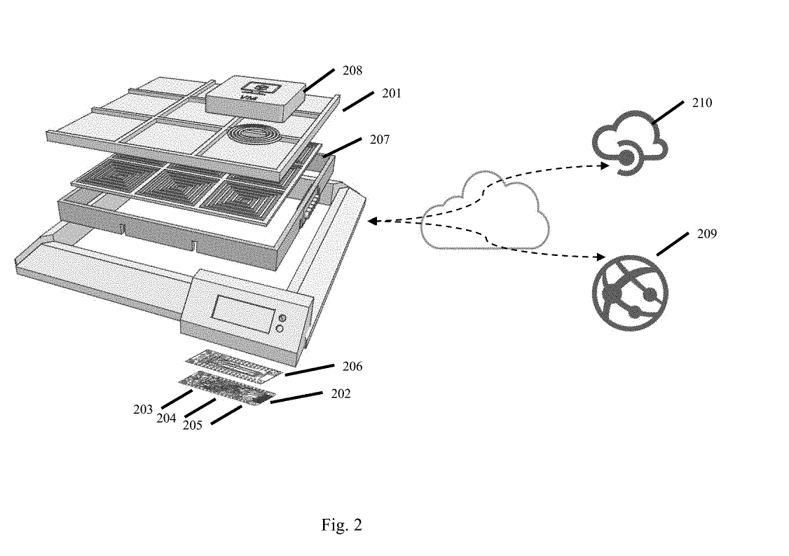

FIG. 2 is an exemplary schematic diagram of the system for creating, reading, updating, or deleting cloud computing resources in accordance with one embodiment of the present invention, which illustrates the process of creating a single virtual machine using the system design in FIG. 1.

As shown in FIG. 2, a tile 208 with a cloud computing resource symbol is placed on the interactive surface 201 to create a new virtual machine. Specifically, “virtual machine” tiles 208 are used to create or update virtual machines. Function buttons, namely menu and select, are located on the user feedback device 206 for the user to interact with.

In order to create cloud computing resources using the system in FIG. 2, a user places various tiles 208 on the interactive surface 201. To create a cloud solution, which is typically made up of numerous cloud computing resources, the user can place various tiles 208 next to each other to indicate relationships between cloud computing resources.

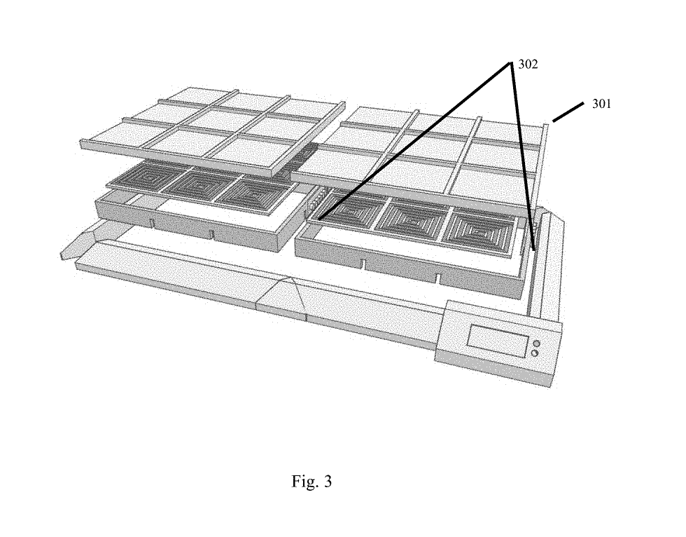

FIG. 3 is an exemplary schematic diagram of the system for creating, reading, updating, or deleting cloud computing resources in accordance with one embodiment of the present invention, which illustrates the connection of multiple interactive surface panels to change the size of the overall interactive surface. Surface panels 301 are electrically connected using spring loaded contacts 302, allowing antenna signals to cascade between two or more interactive surface panels.

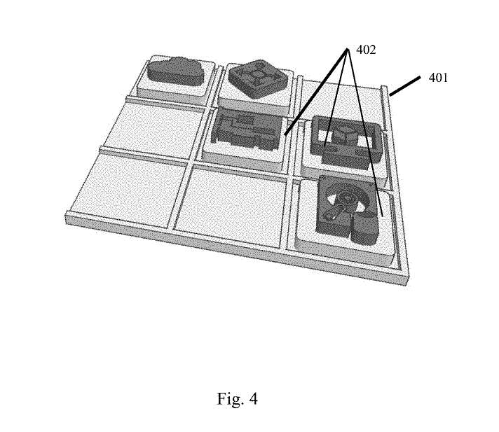

FIG. 4 is an exemplary schematic diagram of the system for creating, reading, updating, or deleting cloud computing resources in accordance with one embodiment of the present invention, which illustrates the process of creating a cloud solution consisting of a public internet connection, load balancer, network interface card, virtual machine, and storage disk using the system design in FIG. 1.

As shown in FIG. 4, several tiles 402 labeled with cloud computing resource symbols are placed on the interactive surface 401 to create a cloud solution. In order to associate cloud computing resources with one another, tiles can be placed next to each other on the interactive surface.

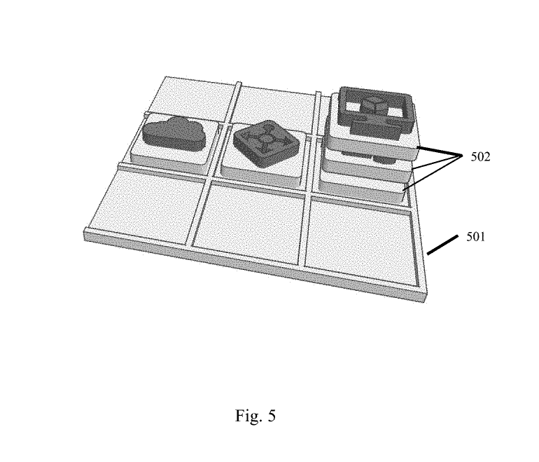

FIG. 5 is an exemplary schematic diagram of the system for creating, reading, updating, or deleting cloud computing resources in accordance with one embodiment of the present invention, which illustrates the process of creating a cloud solution consisting of a public internet connection, load balancer, network interface card, virtual machine, and storage disk using the system design in FIG. 1.

As shown in FIG. 5, several tiles 502 labeled with cloud computing resource symbols are placed on the interactive surface 501 to create a cloud solution. In order to associate cloud computing resources with one another, tiles can be placed on top of each other on the interactive surface.

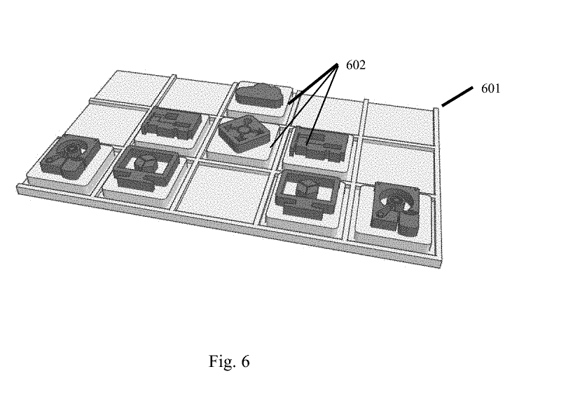

FIG. 6 is an exemplary schematic diagram of the system for creating, reading, updating, or deleting cloud computing resources in accordance with one embodiment of the present invention, which illustrates the process of creating a cloud solution consisting of a public internet connection, load balancer, and several network interface cards, virtual machines, and storage disks using the system design in FIG. 1.

As shown in FIG. 6, several tiles 602 labeled with cloud computing resource symbols are placed on the interactive surface 601 to create a cloud solution. In order to associate cloud computing resources with one another, tiles can be placed next to each other on the interactive surface. For example, to load balance network requests across the two virtual machines, the network interface card tiles are placed next to either side of the load balancer tile.

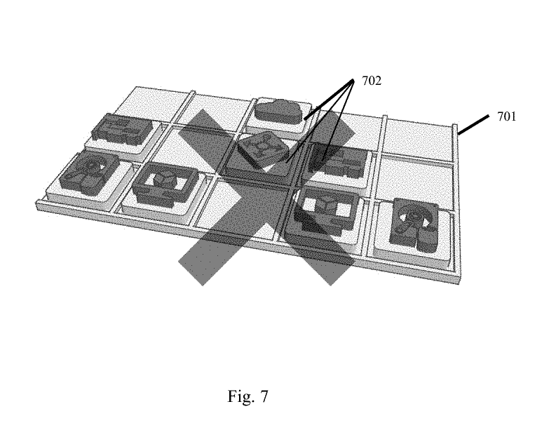

FIG. 7 is an exemplary schematic diagram of the system for creating, reading, updating, or deleting cloud computing resources in accordance with one embodiment of the present invention, which illustrates the process of creating a cloud solution consisting of a public internet connection, load balancer, and several network interface cards, virtual machines, and storage disks using the system design in FIG. 1.

As shown in FIG. 7, several tiles 702 labeled with cloud computing resource symbols are placed on the interactive surface 701 to create a cloud solution. When the end user selects the validate action, an error is found. In this example, there is a network interface card with no associated network connection.

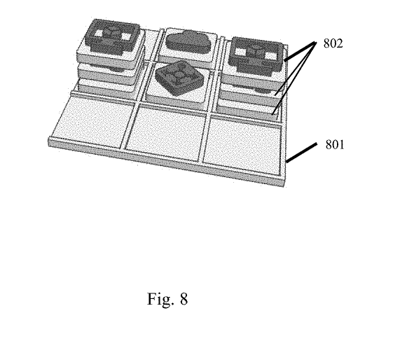

FIG. 8 is an exemplary schematic diagram of the system for creating, reading, updating, or deleting cloud computing resources in accordance with one embodiment of the present invention, which illustrates the process of creating a cloud solution consisting of a public internet connection, load balancer, and several network interface cards, virtual machines, and storage disks using the system design in FIG. 1.

As shown in FIG. 8, several tiles 802 labeled with cloud computing resource symbols are placed on the interactive surface 801 to create a cloud solution. In order to associate cloud computing resources with one another, tiles can be placed on top of each other on the interactive surface. For example, to load balance network requests across the two virtual machines, the network interface card tiles are placed next to either side of the load balancer tile, and a storage disk and virtual machine tile are placed on top of the network interface card tiles.

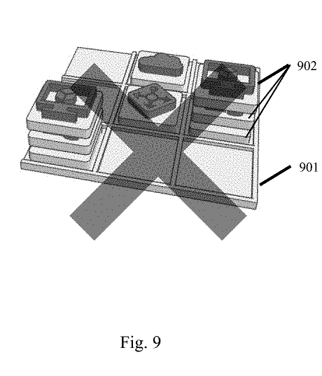

FIG. 9 is an exemplary schematic diagram of the system for creating, reading, updating, or deleting cloud computing resources in accordance with one embodiment of the present invention, which illustrates the process of creating a cloud solution consisting of a public internet connection, load balancer, and several network interface cards, virtual machines, and storage disks using the system design in FIG. 1.

As shown in FIG. 9, several tiles 902 labeled with cloud computing resource symbols are placed on the interactive surface 901 to create a cloud solution. When the end user selects the validate action, an error is found. In this example, there is a network interface card with no associated network connection.

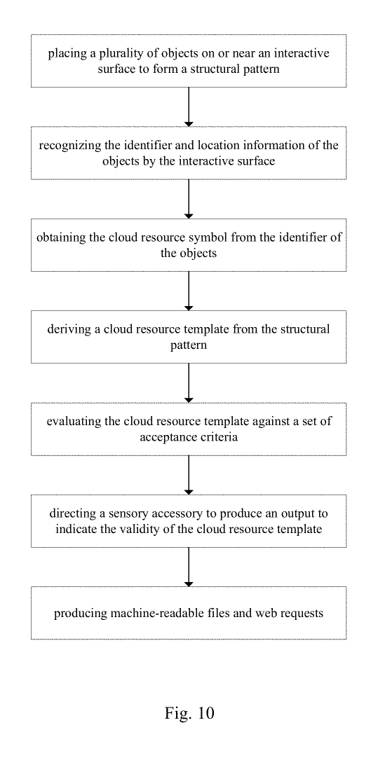

FIG. 10 is an exemplary schematic diagram of the system for creating, reading, updating, or deleting cloud computing resources in accordance with one embodiment of the present invention. As shown in FIG. 10 the method includes the following steps. Step 1001: placing a plurality of objects on or near an interactive surface to form a structural pattern. Step 1002: recognizing the identifier and location information of the objects by the interactive surface. Step 1003: obtaining the cloud resource symbol from the identifier of the objects. Step 1004: deriving a cloud resource template from the structural pattern. Step 1005: evaluating the cloud resource template against a set of acceptance criteria. Step 1006: directing a sensory accessory to produce an output to indicate the validity of the cloud resource template. Step 1007: producing machine-readable files and web requests.

Embodiments of the invention may be further described as a device, system, or method for creating and performing a set of actions, comprising: placing a plurality of objects on or near an interactive surface to form a structural pattern, wherein each object comprises an identifier and is visually marked with a cloud computing resource symbol, and wherein the identifier is encoded with a radio frequency identification (RFID) chip; recognizing the identifier, location and orientation information of an object by the interactive surface upon the object being placed on or near the interactive surface; obtaining, by a processor that is operatively linked to the interactive surface, the cloud computing resource type of the objects from a memory that stores a database of correlation relationships among and between identifiers and cloud computing resource types; deriving, by the processor, machine-readable files. Additionally, the machine-readable file may be formatted for use by an end-user within a cloud computing deployment tool. Additionally, the machine-readable file may be formatted for use by an end-user within a cloud computing designer tool. Additionally, the processor may direct a sensory accessory to produce an output to indicate correct or incorrect placement of objects based on standard cloud computing patterns.

Embodiments of the invention may be further described as a device, system, or method for creating and performing a set of actions, comprising: placing a plurality of objects on or near an interactive surface to form a structural pattern, wherein each object comprises an identifier and is visually marked with a cloud computing resource symbol, and wherein the identifier is encoded with a radio frequency identification (RFID) chip; recognizing the identifier, location and orientation information of an object by the interactive surface upon the object being placed on or near the interactive surface; obtaining, by a processor that is operatively linked to the interactive surface, the cloud computing resource type of the objects from a memory that stores a database of correlation relationships among and between identifiers and cloud computing resource types; deriving, by the processor, web service requests. Additionally, the web requests may be sent to and received from an application program interface (API) used to deploy cloud computing resources. Additionally, the processor may direct a sensory accessory to produce an output to indicate correct or incorrect placement of objects based on standard cloud computing patterns.

Embodiments of the invention may be further described as a device, system, or method for creating and performing a set of actions, comprising: placing a plurality of objects on or near an interactive surface to form a structural pattern, wherein each object comprises an identifier and is visually marked with a cloud computing resource symbol, and wherein the identifier is encoded with a radio frequency identification (RFID) chip; recognizing the identifier, location and orientation information of an object by the interactive surface upon the object being placed on or near the interactive surface; obtaining, by a processor that is operatively linked to the interactive surface, the cloud computing resource type of the objects from a memory that stores a database of correlation relationships among and between identifiers and cloud computing resource types; and upon an action, writing data to the memory of the radio frequency identification (RFID) chip of one or more objects. Additionally, data may be written to the memory of the radio frequency identification (RFID) chip to bring one or more objects up to date. Additionally, data may be written to the memory of the radio frequency identification (RFID) chip to personalize one or more objects to the end-user. Additionally, data may be written to the memory of the radio frequency identification (RFID) chip to associate one or more objects to other objects.

One embodiment of the invention may be further described as a physically interactive cloud computing device comprising: a physical surface; a first movable physical object, wherein the first physical movable object is representative of a first cloud computing resource; a second movable physical object, wherein the second movable physical object is representative of a second cloud computing resource; one or more sensors to sense a first location of the first moveable physical object on the physical surface and a second location the second physical object on the physical surface. This embodiment may also include a link (which may be hardwired or wireless) to communicate the first location of the first physical object on the physical surface and the second location of the second physical object on the physical surface to a processor configured to analyze the same for the purpose of creating, reading, updating, or deleting the first cloud computing resource and the second cloud computing resource.

While the foregoing written description of the invention enables one of ordinary skill to make and use what is considered presently to be the best mode thereof, those of ordinary skill will understand and appreciate the existence of variations, combinations, and equivalents of these specific embodiments. The invention should therefore not be limited by the above described embodiments, but shall include all embodiments within the scope and spirit of the invention.

1. A physically interactive cloud computing device comprising:
a. a physical surface;
b. a first movable physical object, wherein the first physical movable object is representative of a first cloud computing resource;
c. a second movable physical object, wherein the second movable physical object is representative of a second cloud computing resource; and
d. one or more sensors to sense a first location of the first moveable physical object on the physical surface and a second location the second physical object on the physical surface.
